(19) United States
(12) Patent Application Publication
(10) Pub. No.: US 2026/0299950 A1
(43) Pub. Date: Oct. 1, 2026

(54) CACHE SYSTEM AND METHOD FOR PROCESSING CACHE

(71) Applicant: Fujitsu Limited, Kawasaki-shi (JP)

(72) Inventor: Takahito HIRANO, Kawasaki (JP)

(73) Assignee: Fujitsu Limited, Kawasaki-shi (JP)

(21) Appl. No.: 19/551,209

(22) Filed: Feb. 26, 2026

(30) Foreign Application Priority Data
Mar. 26, 2025 (JP) 2025-051441

(51) Int. Cl. G06F 9/30; G06F 12/0897

(52) U.S. Cl. CPC G06F 9/30047; G06F 9/3001; G06F 12/0897

(57) ABSTRACT

According to an aspect of the embodiment, the cache system includes a first arithmetic processing device that includes an internal cache and that determines whether data related to an atomic instruction or an exclusive instruction is hit in the internal cache, and a second arithmetic processing device that includes a Last-Level-Cache (LLC) and that executes the atomic instruction using the data stored in the LLC or executes an exclusive process related to the exclusive instruction when the data is not hit in the internal cache.

### CROSS-REFERENCE TO RELATED APPLICATION

This application is based upon and claims the benefit of priority of the prior Japanese Patent application No. 2025-051441, filed on Mar. 26, 2025, the entire contents of which are incorporated herein by reference.

### FIELD

The embodiments discussed herein are related to a cache system and a method for processing a cache.

### BACKGROUND

In recent development of a Central Processing Unit (CPU), in place of in-house development of an entire CPU, a particular function of a CPU is sometimes accomplished under a licensing contract for Intellectual Property (IP) developed and held by a CPU development manufacturer. Incorporating such a particular function set with IP into own CPU makes it possible to reduce the cost and the time for developing a CPU.

Some Last-Level-Cache (LLC) is also set with IP, which makes it possible to process an instruction set of a CPU in an LLC-IP that can be regarded as an additional value to the function of a normal LLC.

For example, a related art is disclosed in Japanese Laid-open Patent Publication No. 2011-227921.

### SUMMARY

According to an aspect of the embodiment, the cache system includes a first arithmetic processing device that includes an internal cache and that determines whether data related to an atomic instruction or an exclusive instruction is hit in the internal cache, and a second arithmetic processing device that includes a Last-Level-Cache (LLC) and that executes the atomic instruction using the data stored in the LLC or executes an exclusive process related to the exclusive instruction when the data is not hit in the internal cache.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of a cache system according to one embodiment;

FIG. 2 is a flow chart illustrating an Atomic instruction process in the cache system according to the one embodiment;

FIG. 3 is a flow chart illustrating an LDX instruction process in the cache system according to the one embodiment; and

FIG. 4 is a flow chart illustrating an STX instruction process in the cache system according to the one embodiment.

### DESCRIPTION OF EMBODIMENT(S)

In a technique that does not have an Atomic/Exclusive instruction process by an LLC-IP or in a case that does not have an Atomic/Exclusive instruction process on the LLC side when an LLC set with IP is not used, an Atomic arithmetic process or an Exclusive instruction process is performed in the periphery of an L1 cache (i.e., in the CPU core). With this configuration, if a target region does not exist in a cache in the CPU core, the data needs to be read from the LLC and the Atomic/Exclusive instruction process takes time.

On the other hand, if an LLC-IP has the function of Atomic/Exclusive instruction process, the LLC-IP side can perform an Atomic arithmetic operation and Exclusive monitoring. However, for example, in regard to an Atomic arithmetic operation instruction, if the target region for the Atomic arithmetic operation exists in the cache in the CPU core, the data existing in the CPU core needs to be discharged to the LLC and the LLC side needs to perform the Atomic arithmetic process. Consequently, the Atomic/Exclusive instruction process takes time.

Hereinafter, description will now be made in relation to a cache system and a method for processing a cache according to an embodiment will be described. The following embodiment is merely illustrative and is not intended to exclude the application of various modifications and techniques not explicitly described in the embodiments. The present embodiment can be variously modified and implemented without departing from the scopes thereof. Further, each of the drawings by no means intend to include elements appearing therein and can include additional functions not illustrated therein.

### Example of Configuration

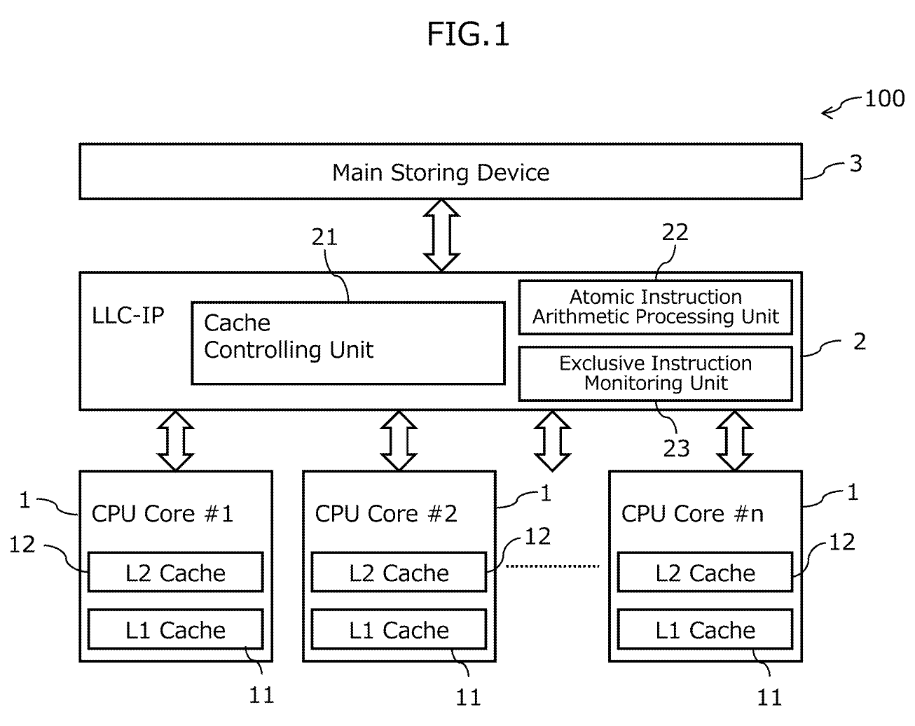

FIG. 1 is a diagram schematically illustrating a configuration of a cache system 100 according to one embodiment;

A cache system 100 illustrated in FIG. 1 includes multiple CPU cores 1 (e.g., CPU cores #1 to #n; where n represents a natural number), an LLC-IP 2, and a main storing device 3.

The main storing device 3 is illustratively a storing device including a Read Only Memory (ROM) and a Random Access Memory (RAM). The RAM may be, for example, a Dynamic RAM (DRAM). In the ROM of the main storing device 3, a program such as a Basic Input/Output System (BIOS) may be written. The software program of the main storing device 3 may be appropriately read into and executed by the CPU core 1. The RAM of the main storing device 3 may also be used as a primary recording memory or a working memory.

Each CPU core 1 is an example of a first arithmetic processing device, and includes a Layer 1 (L1) cache 11 and a Layer 2 (L2) cache 12. The L1 cache 11 and the L2 cache 12 are examples of an internal cache. In the example illustrated in FIG. 1, each CPU core 1 is assumed to include the L1 cache 11 and the L2 cache 12, but alternatively may further include an L3 cache and an L4 cache in addition to the L1 cache 11 and the L2 cache 12.

The cache states of the L1 cache 11 and the L2 cache 12 may be MESI. MESI includes the states of Modified (MOD), Exclusive (EX), Shared (SH), and Invalid (INV).

The MOD indicates a state where a cache line has been modified from the original memory location and only the cache has the most recent version of the data.

EX indicates a state where data a cache line is exclusive to the local CPU core, exclusively accessed by the local CPU, the data has not been modified and is stored in the same position as the original memory position.

SH indicates a state where multiple CPU cores 1 share the same cache line and the data is the same for all the CPU cores 1 and has not been modified.

INV indicates a state where the cache line is invalid and the data is old or does not exist.

Each CPU core 1 is, for example, a processing device that performs various controls and arithmetic operations, and achieves various functions by executing an Operating System (OS) or a program read from the main storing device 3.

The program that achieves various functions in each CPU core 1 may be provided in a form being recorded on a computer-readable recording medium exemplified by a flexible disk, a CD (e.g., CD-ROM, CD-R, CD-RW), a DVD (e.g., DVD-ROM, DVD-RAM, DVD-R, DVD+R, a DVD-RW, DVD+RW, HD DVD), a Blu-ray disk, a magnetic disk, an optical disc, or a magneto-optical disk. The computer (CPU core 1 in the present embodiment) may read the program from the above-described recording medium with a non-illustrated reader and forward the read program to an internal or external memory device for future use. Alternatively, the program may be recorded in a storing device (recording medium) such as a magnetic disk, an optical disk, or a magneto-optical disk, and provided from such a storing device to the computer via a communication path.

When various functions are achieved in the CPU core 1, a program stored in an internal storing device (main storing device 3 in the present embodiment) may be executed by the computer (CPU core 1 in the present embodiment). The program recorded in a recording medium may be read and executed by the computer.

Each CPU core 1 illustratively controls the operation of the entire cache system 100. The device for controlling the operation of the entire cache system 100 is not limited to CPU core 1, and may alternatively be any one of Micro Processing Units (MPUs) Digital Signal Processors (DSPs), Application Specific Integrated Circuits (ASICs), Programmable Logic Devices (PLDs), and Field Programmable Gate Arrays (FPGAs). The device for controlling the operation of the entire cache system 100 may be a combination of two or more types of CPUs, MPUs, DSPs, ASICs , PLDs and FPGAs.

The LLC-IP 2 is an example of a second arithmetic processing device including a Last-Level-Cache (LLC), and includes a cache controlling unit 21, an atomic instruction arithmetic processing unit 22, and an exclusive instruction monitoring unit 23.

The cache controlling unit 21 performs cache control in the LLC of the LLC-IP 2.

The LLC-IP 2 is capable of executing an Atomic/Exclusive instruction process in the IP. Although FIG. 1 illustrates an LLC-IP 2 that can perform an Atomic/Exclusive instruction process, the present embodiment is not limited to connection to an LLC-IP, and alternatively may include a CPU including an LL-cache that can perform an Atomic/Exclusive instruction process.

The atomic instruction arithmetic processing unit 22 carries out an arithmetic process in response to an Atomic instruction issued from the CPU core 1.

An Atomic instruction is an instruction that allows multiple CPUs to execute arithmetic operations, ensuring the consistency of data, even when the multiple CPUs simultaneously access the data. The arithmetic operation of an Atomic instruction includes an operation of comparing the value of a certain region with comparison data and if the values match, newly swapping data (CAS: Compare and Swap), and an operation of comparing the value of a certain region with comparison data and if the values match, adding new data (ADD).

In processing an Atomic instruction, the CPU core 1 searches the state of the L1 cache 11, and requests ,when the state of the L1 cache 11 is INV or SH (hereinafter referred to as "INV/SH"), EX data from the L2 cache 12. When the state of the L1 cache 11 is EX, the atomic instruction process is completed in the L1 cache 11.

An EX data request to the L2 cache 12 in executing an Atomic instruction process is referred to as an EX refill request (atomic).

When receiving an EX refill request (atomic) from the L1 cache 11, the L2 cache 12 searches the state of the L2 cache 12. If the state of the L2 cache 12 is EX, the L2 cache 12 forwards the data to the L1 cache 11. The L1 cache 11 processes the atomic instruction and terminates the process.

If the state of the L2 cache 12 is INV/SH, the CPU core 1 issues an Atomic instruction to the LLC-IP 2. The LLC-IP 2 performs the Atomic process, notifies the CPU core 1 of the completion of the process, and terminates the series of Atomic instruction process.

The exclusive instruction monitoring unit 23 executes an exclusive process related to an Exclusive instruction including a Load Exclusive (LDX) instruction and a Store Exclusive (STX) instruction.

An Exclusive instruction is an instruction that causes a certain CPU to obtain an exclusive right serving as a locking mechanism while multiple CPUs are operating. An Exclusive instruction includes a Load Exclusive instruction and a Store Exclusive instruction, and these two instructions are issued in pair. Specifically, a Load Exclusive instruction makes an attempt to obtain an exclusive right, and a Store Exclusive instruction determines whether the exclusive right was successfully obtained. If the exclusive right is not obtained, a Load Exclusive instruction and a Store Exclusive instruction are issued again and repeatedly issued until the exclusive right is successfully obtained.

In processing a Load Exclusive instruction, the CPU core 1 searches the state of the L1 cache 11, and issues, if the state of the L1 cache 11 is INV, an LD-EX refill request (exclusive) to the L2 cache 12.

If the state of the L1 cache 11 is SH/EX, the CPU core 1 terminates the Load Exclusive instruction process.

When an LD-EX refill request (exclusive) is issued to the L2 cache 12, the L2 cache 12 searches the state of the LD-EX cache 12. If the state of L2 cache 12 is INV/SH, the CPU core 1 issues a LD-EX refill request (exclusive) to the LLC-IP 2. In the LLC-IP 2, the exclusive instruction monitoring unit 23 executes a Load Exclusive instruction process. The LLC-IP 2 forwards the data of the process result to the CPU core 1.

The data forwarded from the LLC-IP 2 is registered in the L1 cache 11 and the L2 cache 12, and the CPU core 1 terminates the Load Exclusive instruction process.

In processing a Store Exclusive instruction of an Exclusive instruction, the CPU core 1 searches the state of the L1 cache 11 and processes, if the state of the L1 cache is INV, the Store Exclusive instruction as a failure.

The CPU core 1 processes, if the state of the L1 cache is EX, the Store Exclusive instruction as a success.

The CPU core 1 issues, if the state of the L1 cache 11 is SH, an ST-EX refill request (exclusive) to the L2 cache 12. If receiving the ST-EX refill request (exclusive) from the L1 cache 11, the L2 cache 12 searches the state of the L2 cache 12. If the L2 cache 12 is in a state of INV, the L2 cache 12 notifies MISS (cache miss) in the L2 cache 12 of the L1 cache 11. The L1 cache 11 processes the Store Exclusive instruction as a failure.

If the L2 cache 12 is in a state of EX, the L2 cache 12 forwards the data to the L1 cache 11. The L1 cache 11 searches the state of the L1 cache 11 again to determine whether the instruction fails or succeeds according to the state of L1 cache 11.

The CPU core 1 issues, if the state of the L2 cache 12 is SH, an ST-EX refill request (exclusive) to the LLC-IP 2. The exclusive instruction monitoring unit 23 of the LLC-IP 2 processes the ST-EX refill (exclusive) and forwards the data to the CPU core 1. The CPU core 1 registers the data in the L1 cache 11 and the L2 cache 12, searches the L1 cache 11, and processes, if the state of the L1 cache 11 is EX, the Store Exclusive as a success. In contrast, if the state of the L1 cache 11 is SH/INV, the CPU core 1 processes the Store Exclusive as a failure.

### Example of Operation

### Atomic Instruction

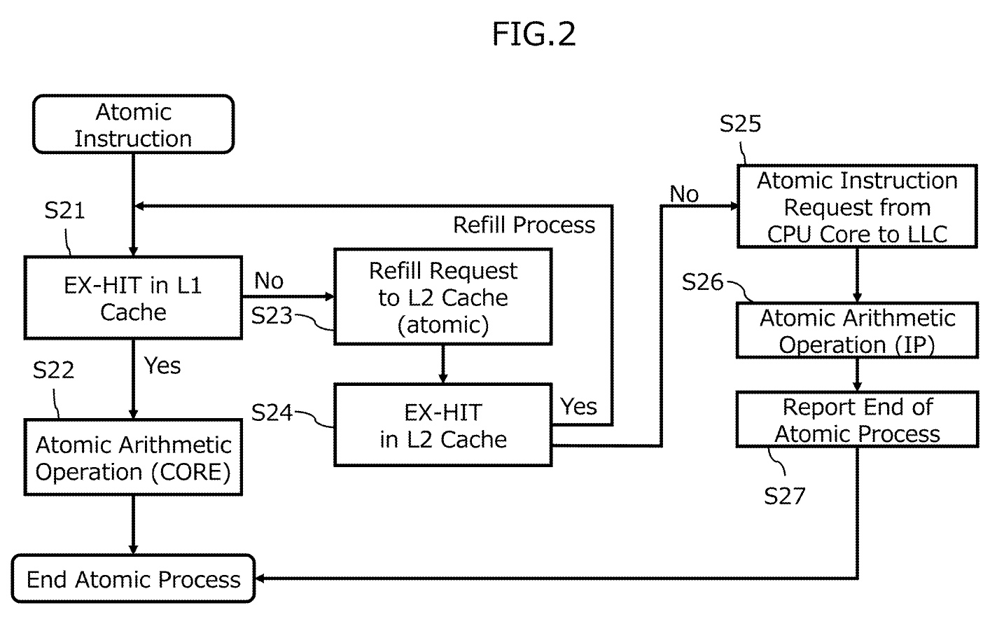

Description will now be made in relation to the Atomic instruction process in the cache system 100 according to the one embodiment with reference to a flow chart (Steps S21-S27) of FIG. 2.

Upon issuing an Atomic instruction, the CPU core 1 determines whether data related to the Atomic instruction is EX-HIT in the L1 cache 11 (Step S21). "EX-HIT" indicates a cache hit in a state where the L1 cache 11 has an exclusive right.

If the data is EX-HIT (found) in the L1 cache 11 (see Yes route in Step S21), the CPU core 1 executes the Atomic arithmetic operation (Step S22), and the process for the Atomic instruction ends.

On the other hand, if the data is not EX-HIT in the L1 cache 11 (see No route in Step S21), the CPU core 1 issues a refill request to the L2 cache 12 (Step S23).

The CPU core 1 determines whether data related to the Atomic instruction is EX-HIT in the L2 cache 12 (Step S24).

If the data is EX-HIT (found) in the L2 cache 12 (see Yes route in Step S24), the CPU core 1 executes a refill process on the L1 cache 11 using data existing in the L2 cache 12, and the process returns to Step S21.

On the other hand, if the data is not EX-HIT in the L2 cache 12 (see No route in Step S24), the CPU core 1 issues an Atomic instruction request to the LLC-IP 2 (Step S25).

The LLC-IP 2 executes an Atomic arithmetic operation using data being related to the Atomic instruction and present in the LLC (Step S26).

The LLC-IP 2 reports the end of the Atomic process to the CPU core 1 (Step S27), and the process for the Atomic instruction ends.

According to the Atomic instruction process of the one embodiment illustrated in FIG. 2, if the data is EX-HIT in the L1 cache 11 or the L2 cache 12, the Atomic arithmetic operation is executed in the CPU core 1. On the other hand, if the data is not EX-HIT in the L1 cache 11 or the L2 cache 12, the Atomic arithmetic operation is executed in the LLC-IP 2. This means that the Atomic arithmetic operation is performed at the place at which the EX-HIT occurs.

### Exclusive Instruction

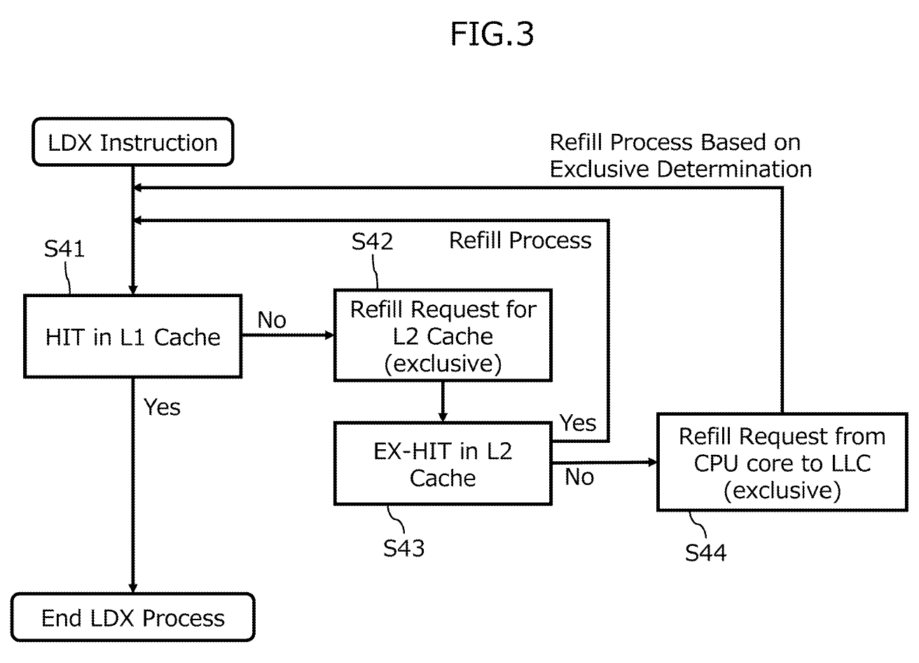

Description will now be made in relation to an LDX instruction process in the cache system 100 configured as the above according to the one embodiment with reference to a flow chart (Steps S41-S44) of FIG. 3.

Upon issuing an LDX instruction, the CPU core 1 determines whether data related to the LDX instruction is HIT in the L1 cache 11 (Step S41).

If the data is HIT (found) in the L1 cache 11 (see Yes route in Step S41), the process for the LDX instruction ends.

On the other hand, if the data is not HIT (found) in the L1 cache 11 (see No route in Step S41), the CPU core 1 issues an exclusive refill request (LD-EX refill request (exclusive)) to the L2 cache 12 (Step S42).

The CPU core 1 determines whether data related to the LDX instruction is EX-HIT in the L2 cache 12 (Step S43).

If the data is EX-HIT (found) in the L2 cache 12 (see Yes route in Step S43), the CPU core 1 executes a refill process on the L1 cache 11 using data existing in the L2 cache 12, and the process returns to Step S41.

On the other hand, if the data is not EX-HIT (found) in the L2 cache 12 (see No route in Step S43), the CPU core 1 issues an exclusive refill request (LD-EX refill request (exclusive)) to the LLC-IP 2 (Step S44). The LLC-IP 2 executes the refill process based on Exclusive determination, and the process returns to Step S41.

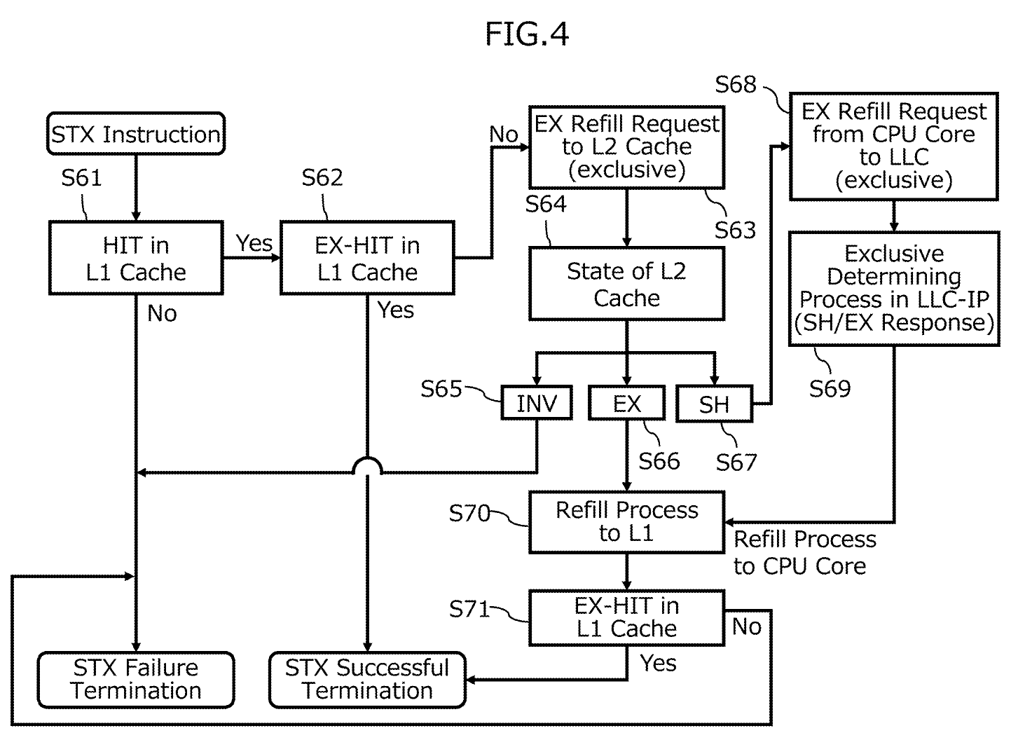

Next, description will now be made in relation to an STX instruction process in the cache system 100 configured as the above according to the one embodiment with reference to a flow chart (Steps S61-S71) of FIG. 4.

The CPU core 1 determines whether data related to the STX instruction is HIT (found) in the L1 cache 11 (Step S61).

If the data is not HIT in the L1 cache 11 (see No route in Step S61), the process for the STX instruction ends as a failure. In this case, the process is restarted from an issue of another LDX (Load Exclusive) instruction.

On the other hand, if the data is HIT (found) in the L1 cache 11 (see Yes route in Step S61), the CPU core 1 determines whether the data related to the STX instruction is EX-HIT in the L1 cache 11 (Step S62).

If the data is EX-HIT in the L1 cache 11 (see Yes route in Step S62), the process for the STX instruction is terminated in success.

On the other hand, if the data is not EX-HIT in the L1 cache 11 (see No route in Step S62), the CPU core 1 issues an EX refill request (ST-EX refill request (exclusive)) to the L2 cache 12 (Step S63).

The CPU core 1 determines the state of the data related to the STX instruction in the L2 cache 12 (Step S64).

If the state in the L2 cache 12 in INV (invalid) (see Step S65), the process for the STX instruction ends as a failure.

If the state in the L2 cache 12 is EX (exclusive) (see Step S66), the process proceeds to Step S70.

If the state in the L2 cache 12 is SH (shared) (see Step S67), the CPU core 1 issues an EX refill request (ST-EX refill request (exclusive)) to the LLC-IP 2 (Step S68).

The LLC-IP 2 performs an Exclusive determination process and responds with SH or EX (Step S69), and performs a refill process on the CPU core 1 from the LLC-IP 2.

The CPU core 1 executes a refill process on the L1 cache 11 (Step S70).

The CPU core 1 determines whether the data related to the STX instruction is EX-HIT in the L1 cache 11 (Step S71).

If the data is EX-HIT in the L1 cache 11 (see Yes route in Step S71), the process for the STX instruction ends as a success.

On the other hand, if the data is not EX-HIT in the L1 cache 11 (see No route in Step S71), the process for the STX instruction ends as a failure.

The Exclusive instruction process according to the one embodiment illustrated in FIGS. 3 and 4 determines whether the STX instruction succeeds or fails according to the state of the L2 cache 12.

### Effects

In the first arithmetic processing device (in this embodiment, the CPU core 1) includes the internal cache and that determines whether data related to an atomic instruction or an exclusive instruction is hit (found) in the internal cache. The second arithmetic processing device (in the present embodiment, the LLC-IP 2) includes an LLC and when the data is not hit (found) in the internal cache, executes the atomic instruction, using the data stored in the LLC or an exclusive process related to the exclusive instruction.

Accordingly, it is possible to shorten the time that the atomic/exclusive instruction process takes.

The first arithmetic processing device executes, when the data is hit (found) in the internal cache, the atomic instruction, using the data stored in the internal cache.

This can shorten the time that the atomic instruction process takes if the data is hit (found) in the internal cache.

The first arithmetic processing device executes, if the data is hit (found) in the internal cache, the exclusive process related to the exclusive instruction.

This can shorten the time that the exclusive instruction process takes if the data is hit (found) in the internal cache.

If the data is not exclusively hit (found) in the L1 cache in executing an exclusive instruction, the first arithmetic processing device refers to the state of the L2 cache 12, and executes, if the state is EX, a refill process from the L2 cache 12 to the L1 cache 11 whereas requests, if the state is SH, the second arithmetic processing device to execute an exclusive refill process from the LLC to the L1 cache 11.

Accordingly, if the data is not hit (found) in the L2 cache 12, the exclusive instruction process can be efficiently accomplished according to the state of the L2 cache 12.

In response to the exclusive refill request from the first arithmetic processing device, the second arithmetic processing device refers to EX or SH as a state of the LLC and executes a refill process to the L1 cache 11 according to a result of the referring.

Accordingly, if the data is not hit (found) in the L1 cache 11 or the L2 cache 12, the exclusive instruction process can be efficiently accomplished according to the state of the L2 cache 12.

### Miscellaneous

The disclosed techniques are not limited to the embodiment described above, and may be variously modified without departing from the scope of the present embodiment.

According to the one embodiment, it is possible to reduce the time that an atomic instruction process or an exclusive instruction process takes.

Throughout the descriptions, the indefinite article “a” or “an” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A cache system comprising:
a first arithmetic processing device that comprises an internal cache and that determines whether data related to an atomic instruction or an exclusive instruction is hit in the internal cache; and
a second arithmetic processing device that comprises a Last-Level-Cache (LLC) and that executes the atomic instruction using the data stored in the LLC or executes an exclusive process related to the exclusive instruction when the data is not hit in the internal cache.

2. The cache system according to claim 1, wherein
when the data is hit in the internal cache, the first arithmetic processing device executes the atomic instruction, using the data stored in the internal cache.

3. The cache system according to claim 1, wherein
when the data is hit in the internal cache, the first arithmetic processing device executes the exclusive process related to the exclusive instruction.

4. The cache system according to claim 1, wherein
the internal cache includes a Layer 1 (L1) cache and a Layer 2 (L2) cache, and
the first arithmetic processing device, in executing the exclusive instruction,
refers to, when the data is not hit in the L1 cache, a state of the L2 cache,
executes, when the state is Exclusive (EX), a refill process from the L2 cache to the L1 cache, and requests, when the state is Shared (SH), the second arithmetic processing device to perform an exclusive refill process from the LLC to the L1 cache.

5. The cache system according to claim 4, wherein
in response to the exclusive refill request from the first arithmetic processing device, the second arithmetic processing device refers to EX or SH as a state of the LLC and executes a refill process to the L1 cache according to a result of the referring.

6. A computer-implemented method for processing a cache, the method comprising:
in a first arithmetic processing device that comprises an internal cache, determining whether data related to an atomic instruction or an exclusive instruction is hit in the internal cache; and
in a second arithmetic processing device that comprises a Last-Level-Cache (LLC), executing the atomic instruction by using the data stored in the LLC or executing an exclusive process related to the exclusive instruction when the data is not hit (found) in the internal cache.

7. The computer-implemented method according to claim 6, further comprising:
in the first arithmetic processing device, when the data is hit in the internal cache, executing the atomic instruction, using the data stored in the internal cache.

8. The computer-implemented method according to claim 6, further comprising:
in the first arithmetic processing device, when the data is hit in the internal cache, executing the exclusive process related to the exclusive instruction.

9. The computer-implemented method according to claim 6, further comprising:
the internal cache including a Layer 1 (L1) cache and a Layer 2 (L2) cache, and
in the first arithmetic processing device, when the exclusive instruction is executed,
referring to, when the data is not hit in the L1 cache, a state of the L2 cache,
executing, when the state is Exclusive (EX), a refill process from the L2 cache to the L1 cache, and requests, when the state is Shared (SH), the second arithmetic processing device to perform an exclusive refill process from the LLC to the L1 cache.

10. The computer-implemented method according to claim 9, wherein
in the second arithmetic processing device, in response to the exclusive refill request from the first arithmetic processing device, referring to EX or SH as a state of the LLC and executes a refill process to the L1 cache according to a result of the referring.
